(19) United States
(12) Patent Application Publication
(10) Pub. No.: US 2023/0402204 A1
(43) Pub. Date: Dec. 14, 2023

(54) CIRCUIT BREAKER HOUSING FORMED USING INJECTION MOLDING WITH A REINFORCEMENT MATERIAL ON AN OUTER SURFACE

(71) Applicant: Rockwell Automation Technologies, Inc., Mayfield Heights, OH (US)

(72) Inventor: Daniel Brugger, Kuettigen (CH)

(21) Appl. No.: 17/749,458

(22) Filed: May 20, 2022

(51) Int. Cl. H01B 3/47; H01H 71/02

(52) U.S. Cl. CPC H01B 3/47; H01H 71/02

(57) ABSTRACT

A component that includes a circuit breaker housing with a reinforcement material impregnated in an outer surface is disclosed. The component includes a circuit breaker housing with outer walls on at least four sides where the circuit breaker housing is formed by injection of a heated wall material into a housing mold. The component includes a reinforcement material impregnated in an outer surface of one or more of the at least four sides. The reinforcement material is bonded to the circuit breaker housing during injection of the heated wall material.

### BACKGROUND INFORMATION

The subject matter disclosed herein relates to circuit breaker housings and more specifically to creating a circuit breaker housing using injection molding where a reinforcement material is located on an outer surface of the circuit breaker housing.

### BRIEF DESCRIPTION

A component that includes a circuit breaker housing with a reinforcement material impregnated in an outer surface is disclosed. The component includes a circuit breaker housing with outer walls on at least four sides where the circuit breaker housing is formed by injection of a heated wall material into a housing mold. The component includes a reinforcement material impregnated in an outer surface of one or more of the at least four sides. The reinforcement material is bonded to the circuit breaker housing during injection of the heated wall material.

A method for forming a circuit breaker housing with a reinforcement material in an outer surface includes positioning a reinforcement material in a housing mold for a circuit breaker housing. The circuit breaker housing includes outer walls on at least four sides and the reinforcement material is positioned to be on an outer surface of one or more of the at least four sides. The method includes injecting a heated wall material, using an injection molding process, in a portion of the housing mold interior to the reinforcement material to form the circuit breaker housing. The heated wall material bonds to the reinforcement material as the heated wall material is injected in the housing mold and the reinforcement material is in the outer surface of the one or more of the at least four sides of the circuit breaker housing.

Another method for forming a circuit breaker housing with a reinforcement material in an outer surface includes heating a reinforcement material impregnated with a bonding material where the bonding material is heated to a pliable state, placing the heated reinforcement material into a reinforcement mold, and pressing the reinforcement material in the reinforcement mold into a shape matching a shape of an outer surface of a circuit breaker housing. The circuit breaker housing includes outer walls on at least four sides and the reinforcement material is positioned to be on an outer surface of one or more of the at least four sides. The method includes positioning the reinforcement material in a housing mold for the circuit breaker housing, injecting a heated wall material, using an injection molding process, in a portion of the housing mold interior to the reinforcement material to form the circuit breaker housing, and removing the circuit breaker housing from the housing mold. The bonding material of the reinforcement material is heated to a temperature such that the heated wall material bonds to the reinforcement material as the heated wall material is injected in the housing mold, and the reinforcement material is in one or more of the outer walls of the at least four sides of the circuit breaker housing.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a diagram of a circuit breaker housing, according to various embodiments;

FIG. 2 is a diagram of a circuit breaker housing with reinforcement material on one side, according to various embodiments;

FIG. 3 is a diagram of a circuit breaker housing with reinforcement material around the circuit breaker housing, according to various embodiments;

FIG. 4 is a diagram of a circuit breaker housing with reinforcement material in U-shaped strips, according to various embodiments;

FIG. 5 is a diagram of a circuit breaker housing with reinforcement material in a band around a top portion and U-shaped strips, according to various embodiments;

FIG. 6 is a diagram of an isolated view of the reinforcement material of the circuit breaker housing of FIG. 5, according to various embodiments;

FIG. 7 is a schematic block diagram illustrating a process for creating a portion of a circuit breaker housing with heated reinforcement material, according to various embodiments;

FIG. 8 is a diagram illustrating a process for creating a portion of a circuit breaker housing by placing reinforcement material in a mold and holding the reinforcement material in place with a vacuum before an injection process, according to various embodiments;

FIG. 9 is a diagram illustrating a mold for placement of a reinforcement material in position held by pins, according to various embodiments;

FIG. 10 is a diagram illustrating a cross section of a reinforcement material bonded to an injected wall material, according to various embodiments;

FIG. 11 is a schematic flowchart diagram illustrating a method for creating a circuit breaker housing using an injected wall material with a reinforcement material along an outer surface, according to various embodiments;

FIG. 12 is a schematic flowchart diagram illustrating a method for creating a circuit breaker housing using an injected wall material with a reinforcement material along an outer surface where the reinforcement material is heated and pressed into shape, according to various embodiments; and

FIG. 13 is a schematic flowchart diagram illustrating a method for creating a circuit breaker housing using an injected wall material with a reinforcement material along an outer surface where the reinforcement material is positioned in a mold and pinned in position, according to various embodiments.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims or may be learned by the practice of embodiments as set forth hereinafter. As will be appreciated by one skilled in the art, aspects of the present invention may be embodied as a system, method, and/or process. Accordingly, aspects of the present invention to control a process may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (“RAM”), a read-only memory (ROM), an erasable programmable read-only memory (“EPROM” or Flash memory), a portable compact disc read-only memory (“CD-ROM”), a digital versatile disc (“DVD”), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

Program code for carrying out operations for aspects of the present invention may be written in any combination of one or more programming languages, including an object-oriented programming language such as Python, Ruby, R, Java, Java Script, Smalltalk, C++, C sharp, Lisp, Clojure, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The computer program product may be shared, simultaneously serving multiple customers in a flexible, automated fashion.

The schematic flowchart diagrams and/or diagrams in the Figures illustrate the architecture, functionality, and operation of possible implementations. It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Although various arrow types and line types may be employed in the flowchart and/or block diagrams, they are understood not to limit the scope of the corresponding embodiments. Indeed, some arrows or other connectors may be used to indicate only an exemplary logical flow of the depicted embodiment.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C.

A component that includes a circuit breaker housing with a reinforcement material impregnated in an outer surface is disclosed. The component includes a circuit breaker housing with outer walls on at least four sides where the circuit breaker housing is formed by injection of a heated wall material into a housing mold. The component includes a reinforcement material impregnated in an outer surface of one or more of the at least four sides. The reinforcement material is bonded to the circuit breaker housing during injection of the heated wall material.

In some embodiments, fibers of the reinforcement material are positioned in the one or more of the at least four sides in a direction to fortify the circuit breaker housing to resist pressures caused in a short circuit condition. In other embodiments, the reinforcement material includes unidirectional fibers. In other embodiments, the reinforcement material includes two or more layers where each layer of the two or more layers includes fibers running in a different direction than fibers of another layer of the two or more layers.

In some embodiments, a portion of the reinforcement material wraps around two or more adjacent sides of the circuit breaker housing. In other embodiments, the portion of the reinforcement material wraps in a loop around four adjacent sides of the circuit breaker housing. In other embodiments, the portion of the reinforcement material that wraps in a loop around the four adjacent sides of the circuit breaker housing includes a strip less than a width of each of the four adjacent sides where the width is measured in a direction perpendicular to the loop of reinforcement material and the circuit breaker housing includes one or more strips of the reinforcement material running in a direction perpendicular to the loop of reinforcement material.

In some embodiments, the wall material includes a thermoplastic resin. In other embodiments, the reinforcement material is impregnated with a bonding material capable of bonding to the heated wall material when heated. In other embodiments, the reinforcement material is the same as the wall material. In other embodiments, the component includes a circuit breaker within the circuit breaker housing and/or and a faceplate attached to a side of the circuit breaker housing.

A method for forming a circuit breaker housing with a reinforcement material in an outer surface includes positioning a reinforcement material in a housing mold for a circuit breaker housing. The circuit breaker housing includes outer walls on at least four sides and the reinforcement material is positioned to be on an outer surface of one or more of the at least four sides. The method includes injecting a heated wall material, using an injection molding process, in a portion of the housing mold interior to the reinforcement material to form the circuit breaker housing. The heated wall material bonds to the reinforcement material as the heated wall material is injected in the housing mold and the reinforcement material is in the outer surface of the one or more of the at least four sides of the circuit breaker housing.

In some embodiments, the reinforcement material is impregnated with a bonding material capable of bonding to the heated wall material when heated. In other embodiments, the method includes, prior to positioning the reinforcement material in the housing mold, heating the reinforcement material such that the bonding material is in a pliable state and pressing the reinforcement material into a shape matching a shape of an outer surface of the circuit breaker housing. In other embodiments, the method includes, after positioning the reinforcement material in the housing mold and prior to injecting the heated wall material, restraining the reinforcement material in a position where the reinforcement material was positioned in the housing mold.

In some embodiments, positioning the reinforcement material in the housing mold includes positioning fibers of the reinforcement material in the housing mold in a location and direction to fortify the circuit breaker housing to resist pressures caused in a short circuit condition. In other embodiments, the reinforcement material includes two or more layers where each layer of the two or more layers includes fibers running in a different direction than fibers of another layer of the two or more layers. In other embodiments, the reinforcement material is impregnated with a bonding material capable of bonding to the heated wall material when heated.

Another method for forming a circuit breaker housing with a reinforcement material in an outer surface includes heating a reinforcement material impregnated with a bonding material where the bonding material is heated to a pliable state, placing the heated reinforcement material into a reinforcement mold, and pressing the reinforcement material in the reinforcement mold into a shape matching a shape of an outer surface of a circuit breaker housing. The circuit breaker housing includes outer walls on at least four sides and the reinforcement material is positioned to be on an outer surface of one or more of the at least four sides. The method includes positioning the reinforcement material in a housing mold for the circuit breaker housing, injecting a heated wall material, using an injection molding process, in a portion of the housing mold interior to the reinforcement material to form the circuit breaker housing, and removing the circuit breaker housing from the housing mold. The bonding material of the reinforcement material is heated to a temperature such that the heated wall material bonds to the reinforcement material as the heated wall material is injected in the housing mold, and the reinforcement material is in the outer walls of the at least four sides of the circuit breaker housing.

In some embodiments, positioning the reinforcement material in the housing mold includes positioning fibers of the reinforcement material in the housing mold in a location and direction to fortify the circuit breaker housing to resist pressures caused in a short circuit condition.

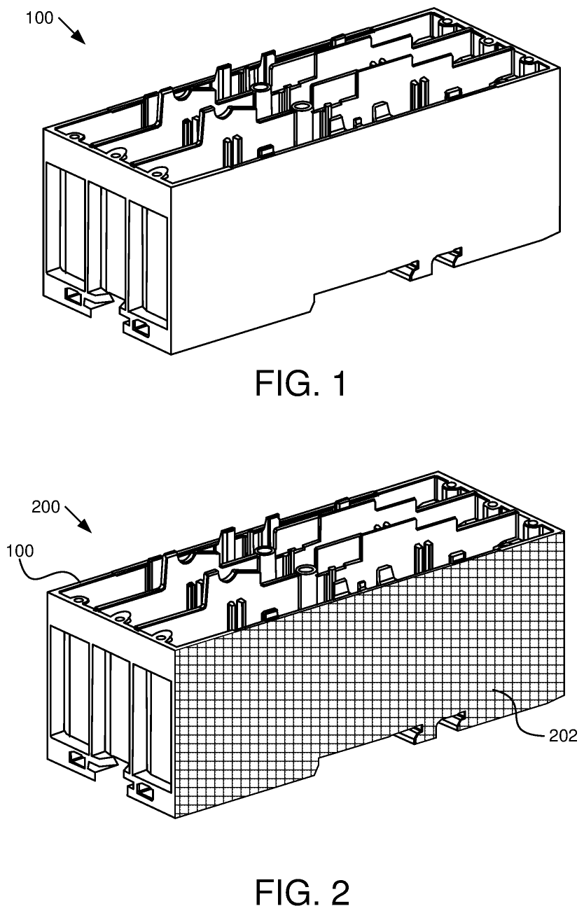

FIG. 1 is a diagram of a circuit breaker housing 100, according to various embodiments. A circuit breaker housing is a structure that is shaped and designed to hold a circuit breaker. The circuit breaker housing 100 of FIG. 1 is for a molded case circuit breaker (“MCCB”). A molded case circuit breaker is typically larger than a miniature circuit breaker (“MCB”), which are often found in electrical panels and often range from 1 ampere (“A”) to 100 A. MCCBs typically range from 15 A to 2500 A. In some embodiments, the circuit breaker housing 100 is for a miniature circuit breaker.

Note that FIG. 1 is for a particular circuit breaker that is representative of other circuit breakers and the embodiments described herein are applicable to various circuit breaker types. In addition, while the embodiments described herein include circuit breakers, the techniques described herein are also applicable to other electrical devices that interrupt electrical current, such as a disconnect switch, a fused disconnect, a manual motor controller, a combination motor controller, a molded case circuit breaker, a motor protection circuit breaker, a protection device within bucket in a motor control center, or other electrical device formed using injection molding and subject to the forces associated with opening contacts and short circuit conditions.

A circuit breaker is an electrical safety device designed to protect an electrical circuit from damage caused by a short circuit or overload. A circuit breaker is designed to open a set of contacts to interrupt current flow when current is above a rated ampacity. Typically, a circuit breaker has an inverse-time characteristic where currents just above the rated ampacity cause the circuit breaker to open after a relatively long period of time, such as minutes or hours, and high currents cause the circuit breaker to open quickly, in as little as a few milliseconds.

In a short circuit current situation where there is a short from line to ground, the short circuit current may be very high and is limited only by resistance of the short circuit and conductors. Short circuit currents are often in the tens of thousands of amps and maybe in the hundreds of thousands of amps. Opening the contacts of the circuit breaker in these conditions causes arcing across the contacts which results in high pressure within the circuit breaker housing.

Short circuit ratings are typically expressed in terms of amps interrupting capacity (“AIC”) or short circuit current rating (“SCCR”). AIC describes the maximum fault current that a protective device can clear safely without welding closed contacts or causing damage to equipment or personnel. SCCR applies to complete pieces of equipment, such as motor control enclosures that include circuit breakers, fuses, contactors, etc. and describes the maximum fault current that the equipment can withstand safely or the maximum available fault current of the feeder to which the equipment can be safely connected. AIC is typically in the range of 5,000 to 200,000 amperes (“A”) and SCCR is usually in the range of 18,000 to 200,000 A.

Where actual short circuit current exceeds the AIC or SCCR rating of a protective device, pressures caused by arcing current typically cause the protective device to explode, which can injure personnel, can cause a fire, or other catastrophic event. Thus, circuit breaker housings are designed to withstand high pressures caused by arcing currents of a short circuit condition. Typically, the outer walls of the circuit breaker housing bear the forces of the pressures from arcing current. Interior walls typically experience about the same pressures on both sides while outer walls experience a pressure force from the inside toward the outside of the circuit breaker housing. The outer walls of the circuit breaker housing are designed to withstand the forces caused by the pressure of arcing current in a short circuit condition. The outer walls may expand to some degree outwards during an arcing current event.

Circuit breakers are typically designed to have certain housing sizes to fit within motor control centers, distribution panels, motor starters, and the like. For a particular circuit breaker housing size, a particular circuit breaker type is often limited certain ampacity ratings. For example, an MCB may range from 1 A to 100 A. A certain 100 A frame size may have ampacities from 16 A to 100 A, while a larger 225 A frame size may have ampacities from 100 A to 225 A. A goal in design of a circuit breaker is get as much ampacity into a particular frame size as possible while considering AIC or SCCR ratings, wire sizes, contact sizes, etc. Increasing ampacity of a particular circuit breaker housing size is desirable.

Choice of materials for circuit breaker housings are driven by electrical characteristics as well as other factors, such as flammability, strength, cost, etc. Typically, a circuit breaker housing material has good insulation characteristics, which typically eliminates conductive materials, such as metal. Often circuit breaker housings are constructed of materials that are a thermoplastic resin such as polyamides and nylons (which is a type of polyamide), both of which have good electrical insulating characteristics in addition to other desirable characteristics.

One desirable characteristic of circuit breaker housing material is an ability to be easily shaped into an appropriate form. One common method for creating a circuit breaker housing is an injection molding process where a heated material, which may be referred to herein as a wall material, is heated to a liquid state and injected into a mold. The wall material is used to construct the walls and other parts of the circuit breaker housing. Once the wall material in the housing mold cools, the wall material hardens into a solid state and the circuit breaker housing is expelled from the housing mold. The AIC and/or SCCR rating of the circuit breaker is dependent on properties of the selected wall material in conjunction with the shape of the circuit breaker housing, thickness of the outer walls of the circuit breaker housing, and the like.

In some embodiments, the wall materials suitable for a circuit breaker housing include materials that perform well in the Comparative Tracking Index (“CTI”), the Glow Wire Flammability Index (“GWFI”), and the Underwriters Laboratories (“UL”) 94 flammability test. The Comparative Tracking Index is used to measure the electrical breakdown (e.g., tracking) properties of insulating materials. Tracking is an electrical breakdown on the surface of an insulating material where an initial exposure to electrical arcing carbonizes the material. The carbonized areas are more conductive than the material prior to electrical exposure and lead to increased current flow, resulting in increased heat generation, and eventually the insulation becomes completely conductive. For the Glow Wire Flammability Index, a hot wire is heated to a specific temperature and pressed against the wall material for 30 seconds. If ignition occurs, the duration, flame height and if drips of the material ignite tissue paper are recorded. For the UL 94 flammability test, an open flame is placed a certain distance below the wall material positioned at various angles for a specific period of time and flammability characteristics are noted and give rise to various UL 94 ratings. In embodiments described herein, the wall material is any material that can be injection molded and does well on the CTI test, the GWFI test, the UL 94 flammability test, and/or other relevant tests.

In addition, suitable wall materials have other desirable characteristics selected from such categories as flexibility, material hardness, material weight, material cost, and the like. In some embodiments, a suitable wall material is a polyamide. In some examples, the polyamide is a nylon. In other embodiments, the wall material is a polyester, such as polybutylene terephthalate (“PBT”). In some embodiments, various forms of wall materials are able to be used for injection molding and include suitable electrical characteristics, flammability characteristics, and the like, which make these forms of materials suitable for a circuit breaker housing.

In embodiments described herein, a reinforcement material is embedded in an outer surface of exterior walls of a circuit breaker housing and are positioned in such a way as to strengthen the outer walls of the circuit breaker housing against forces caused by the pressure of an arcing current during short circuit conditions. The reinforcement material, in some embodiments, includes fibers strategically positioned in one or more directions to oppose the forces caused by the pressures of short circuit arcing.

Beneficially, having the reinforcement material embedded in an outer surface of a circuit breaker housing 100 provides various benefits. In some examples, the walls of the circuit breaker housing 100 can be thinner than circuit breaker housings without the reinforcement material. In other examples, a circuit breaker housing 100 with reinforcement material embedded in outer walls allows for higher short circuit current ratings, which allows for a higher ampacity for a same size frame. For example, a 100 A frame size may be used for a 125 A circuit breaker where reinforcement material is added to the circuit breaker housing 100. One of skill in the art will recognize other benefits of a circuit breaker housing 100 with a reinforcement material embedded in outer walls of the circuit breaker housing 100.

FIG. 2 is a diagram 200 of a circuit breaker housing 100 with reinforcement material 202 on one side, according to various embodiments. In the diagram 200 of FIG. 2, the reinforcement material 202 is positioned to cover an outer surface of the circuit breaker housing 100. While the reinforcement material 202 is depicted on one outer surface of the circuit breaker housing 100, in other embodiments, the reinforcement material 202 covers other outer surfaces of the circuit breaker housing 100. The pattern of the reinforcement material 202 in FIG. 2 is merely meant to distinguish the reinforcement material 202 from other materials and surfaces of the circuit breaker housing 100 and is not intended to depict actual direction of the fibers of the reinforcement material 202.

In some embodiments, fibers of the reinforcement material 202 run in a single direction (e.g., unidirectional). For example, the fibers of the reinforcement material 202 may run side-to-side, top-to-bottom or at a particular angle with respect to the circuit breaker housing 100. In other embodiments, the reinforcement material 202 include W multiple layers of fibers running in different directions. In some examples, a first layer has fibers running in a first direction and a second layer with fibers running perpendicular to the first direction. In some embodiments, the reinforcement material 202 has two or more layers pressed or otherwise bound together.

In some embodiments, the reinforcement material 202 is impregnated with a bonding material capable of bonding to the heated wall material when heated. In some examples, the bonding material is similar to the wall material with chemical properties, insulating properties, etc. similar to the wall material. In some embodiments, the bonding material has a melting point similar or less than the wall material and softens sufficiently during injection molding to bond to the wall material. In some embodiments, the bonding material is the same as the wall material.

In some embodiments, the reinforcement material 202 impregnated with the bonding material is heated prior to injection molding. In some examples, the reinforcement material 202 impregnated with the bonding material is heated to a temperature so that the thermal energy of coming in contact with the wall material during injection molding causes the bonding material to melt and bond to the wall material. In the examples, failure to heat the reinforcement material 202 impregnated with the bonding material or failure to heat the reinforcement material 202 impregnated with the bonding material to a proper temperature may cause insufficient bonding between the reinforcement material 202 and the wall material. Thus, the reinforcement material 202 is heated to a sufficient temperature just before coming in contact with the wall material during injection molding.

The reinforcement material 202 typically includes a material with fibers running in a particular direction. The fibers are of a material such that the reinforcement material 202 is strong with regard to forces in a direction of the fibers and may be weaker in other directions. The fibers may be fiberglass, carbon fiber, or other suitable material. In some embodiments, the reinforcement material 202 has good insulation properties. In some embodiments, conductive fibers, such as metal, are excluded. In some embodiments, the reinforcement material 202 comes in the form of a tape. In other embodiments, the reinforcement material 202 come in the form of a sheet. In some embodiments, the reinforcement material 202 has fibers running in multiple directions. For example, the reinforcement material 202 may include fibers in a first direction and other fibers running perpendicular to the to the first direction. In other embodiments, the reinforcement material 202 has more than two layers of fibers. In other embodiments, the layers of fiber are pressed, glued, bonded, etc. together into the reinforcement material 202.

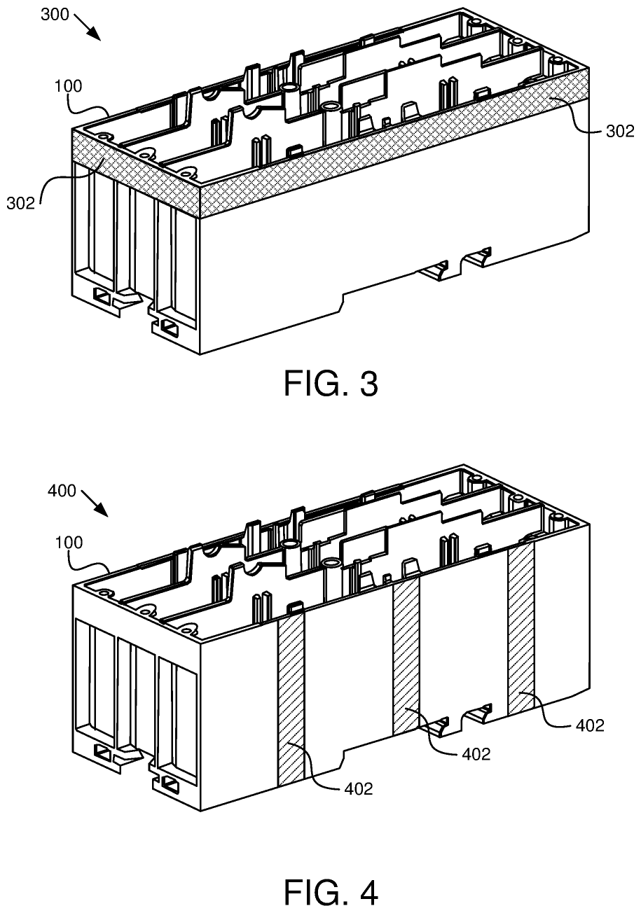

FIG. 3 is a diagram 300 of a circuit breaker housing 100 with reinforcement material 302 around the circuit breaker housing 100, according to various embodiments. The reinforcement material 302, in some embodiments, is the same material as the reinforcement material 202 of FIG. 2. In some embodiments, the reinforcement material 302 wraps around two or more adjacent sides of the circuit breaker housing 100. In some examples, the reinforcement material 302 wraps along an entire side and then partially around adjacent sides to provide additional strength. In other embodiments, the reinforcement material 302 wraps in a loop around four adjacent sides of the circuit breaker housing 100. While the reinforcement material 302 is depicted in a narrow band in FIG. 3, in other embodiments, the reinforcement material 302 is wider. In other embodiments, the reinforcement material 302 is wrapped around the circuit breaker housing in multiple locations. In various embodiments, the reinforcement material 302 is strategically added to various locations to reinforce the outer walls of the circuit breaker housing 100 at particular points.

FIG. 4 is a diagram 400 of a circuit breaker housing 100 with reinforcement material 402 in U-shaped strips, according to various embodiments. The reinforcement material 402 is similar to the material of the reinforcement material 202 in FIG. 2. In FIG. 3, the reinforcement material 402 is depicted on a single side but also wraps under and behind the circuit breaker housing 100 as depicted in FIG. 6. The U-shaped reinforcement material 402 are placed as needed to add additional reinforcement to the outer walls of the circuit breaker housing 100. U-shaped strips of the reinforcement material 402 may be necessary in certain directions to avoid an open side of the circuit breaker housing 100.

Note that the reinforcement material 402 in FIG. 4 has a different pattern different than the pattern of the reinforcement material 302 of FIG. 3. The pattern is meant only for convenience to depict the reinforcement material 402 and is not meant to depict direction of fibers. In some embodiments, fibers of the reinforcement material 402 as well as the fibers in the band of reinforcement material 302 in FIG. 3 run in the direction of the bands of reinforcement materials 302, 402. In other embodiments, the reinforcement materials 302, 402 include one or more additional layers with fibers of a layer running in a direction different than the bands of reinforcement materials 302, 402.

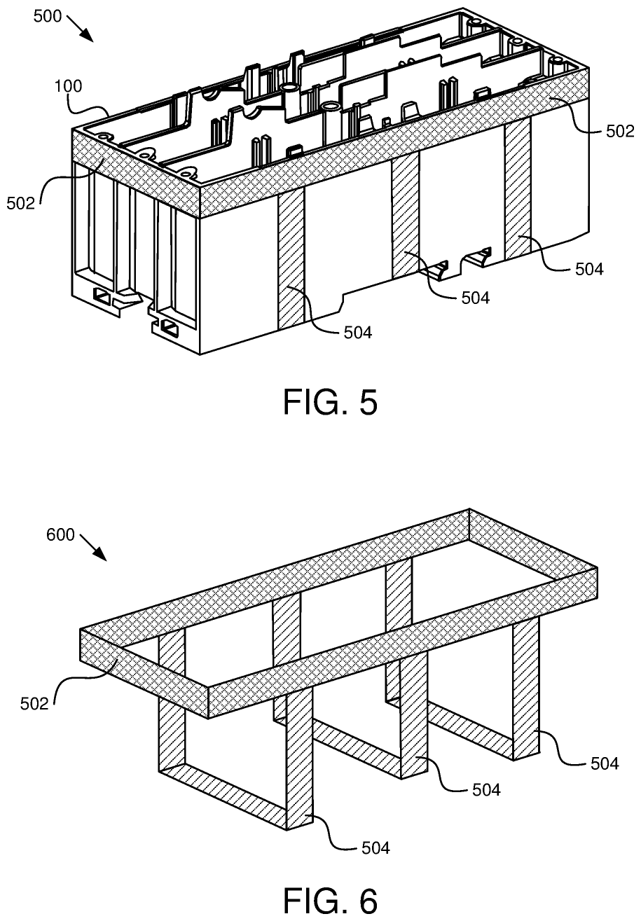

FIG. 5 is a diagram 500 of a circuit breaker housing 100 with reinforcement material in a band 502 around a top portion and U-shaped strips 504. The band 502 and U-shaped strips 504, in some embodiments, are a combination of the reinforcement material 302, 402 of FIGS. 3 and 4. In some embodiments, the U-shaped strips 504 are connected to the band 502. In other embodiments, the U-shaped strips 504 are not connected to the band 502. FIG. 6 is a diagram 600 of an isolated view of the reinforcement material 502, 504 of the circuit breaker housing 100 of FIG. 5, according to various embodiments. The band 502 and U-shaped strips 504 of reinforcement material add a cage-like design, which would be less expensive than to wrap the outer surfaces as depicted in FIG. 2. One of skill in the art will recognize other designs of reinforcement material to be placed on and bonded to a wall material of a circuit breaker housing 100.

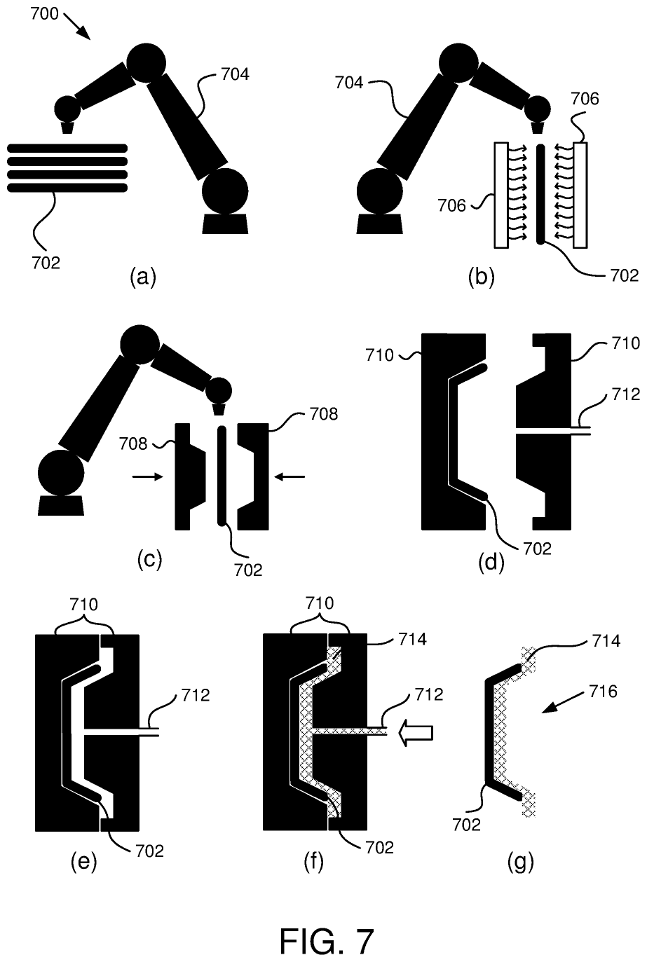

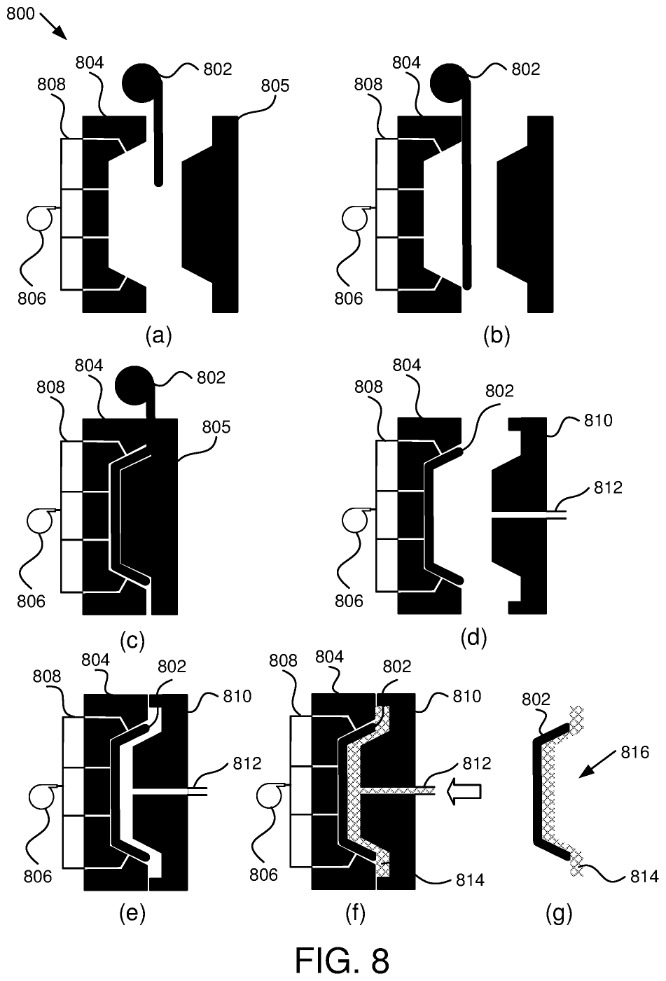

FIG. 7 is a diagram illustrating a process 700 for creating a portion of a circuit breaker housing 100 with heated reinforcement material 702, according to various embodiments. The process 700 begins with a sheet of reinforcement material 702 being picked up (a) by a robotic arm 704 and placed (b) in a heater 706. In other embodiments, a robotic arm 704 is not used and some other mechanism or person moves the reinforcement material 702. In some embodiments, the heater 706 includes an infrared heat source. In other embodiments, the heater 706 is an oven. In other embodiments, the heater 706 includes electric heat elements. The heater 706, in other embodiments, uses natural gas for heating. One of skill in the art will recognize other types of heaters 706.

The process 700 places (c) a heated sheet of reinforcement material 702 in a reinforcement mold 708 where the sheet of reinforcement material 702 is pressed into a particular shape. The heated reinforcement material 702 is rotated and placed (d) to a housing mold 710 with an opening 712 for injection molding. The housing mold is moved (e) together and heated wall material is injected (f) into the housing mold 710 through one or more openings 712. The finished part 716 includes wall material 714 and reinforcement material 702 on an exterior surface. Note that the finished part 716 is intended to represent a circuit breaker housing 100 where depiction of the entire circuit breaker housing 100 in each step of the process 700 of FIG. 7 would be difficult in terms of clarity. As contemplated herein, the process 700 of FIG. 7 is applicable to an entire circuit breaker housing 100. The circuit breaker housing 100 may be constructed in a single injection molding process or multiple injection molding processes.

FIG. 8 is a diagram illustrating a process 800 for creating a portion of a circuit breaker housing 100 by placing reinforcement material 802 in a housing mold with a first section 804 and a positioning piece 805 and holding the reinforcement material 802 in place with a vacuum 806 before an injection process, according to various embodiments. The process begins with the housing mold 804, 805 open and the reinforcement material 802 being fed (a) into the housing mold 804, 805. The reinforcement material 802 is depicted in a roll but may be a sheet or other suitable form. The housing mold first section 804 includes vacuum ports 808 intended to hold the reinforcement material 802 in place using a vacuum force exerted by the vacuum 806.

The process 800 extends (b) the reinforcement material 802 to a particular length and closes (c) the positioning piece 805 of the housing mold to press the reinforcement material 802 against the first section 804 of the housing mold. The process 800 operates the vacuum 806 in conjunction with the vacuum ports 808 to hold the reinforcement material 802 in place and moves (d) a second section 810 of the housing mold with an opening 812 for injection material into place and then moves (e) against the first section 804 while the vacuum 806 continues to hold the reinforcement material 802 in place. The process 800 injects (f) heated wall material 814 into the opening 812 to fill the space behind the reinforcement material 802. The process 800 extracts (g) the final part 816 from the housing mold 804, 810 and includes wall material 814 with the reinforcement material 802 on an exterior surface.

Note that as with the process 700 of FIG. 7, the finished part 816 is intended to represent a circuit breaker housing 100 where depiction of the entire circuit breaker housing 100 in each step of the process 800 of FIG. 8 would be difficult in terms of clarity. As contemplated herein, the process 800 of FIG. 8 is applicable to an entire circuit breaker housing 100. The circuit breaker housing 100 may be constructed in a single injection molding process or multiple injection molding processes. Note also that while the process 800 of FIG. 8 depicts a positioning piece 805 in addition to a second section 810 of the housing mold, in other embodiments the second section 810 is used to move the reinforcement material 802 close enough for the vacuum ports 808 to take effect and to suck the reinforcement material 802 against the first section 804 of the housing mold.

In other embodiments, the positioning piece 805 is shaped differently. For example, the positioning piece 805 may include arms, rods, etc. that may be moved to push the reinforcement material 802 into place. In some embodiments, a location where the reinforcement material is 802 is flat and applying a vacuum force is sufficient to pull the reinforcement material 802 into place without a positioning piece 805. One of skill in the art will recognize other methods of moving the reinforcement material 802 into position so that vacuum forces are able to hold the reinforcement material 802 into place.

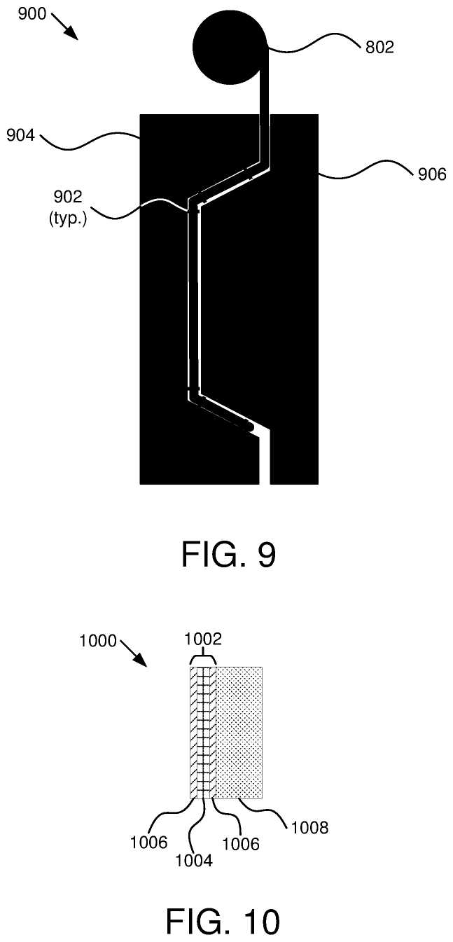

FIG. 9 is a diagram 900 illustrating a housing mold for placement of a reinforcement material 802 in position held by pins 902, according to various embodiments. The housing mold has a first section 904 and a second section 906. As the second section 906 moves toward the first section 904, in some embodiments the second section 906 presses the reinforcement material 802 onto the pins 902. In other embodiments, after the second section 906 positions the reinforcement material 802, the pins 902 move into place to hold the reinforcement material 802. In other embodiments, the second section 906 is a section of the housing mold. In other embodiments, the second section 906 includes arms, rods, discrete parts, etc. that move the reinforcement material 802 into place on the pins 902. While examples of holding the reinforcement material 802 in place include use of a vacuum force and pins, other methods may also be used, such as gluing the reinforcement material 802 in place using hot melted plastic, wall material, bonding material, or the like. In other embodiments, the glue is another material that is not heated. One of skill in the art will recognize other ways to hold the reinforcement material 802 in place until heated wall material is injected into a housing mold.

FIG. 10 is a diagram illustrating a cross section 1000 of a reinforcement material 1002 bonded to an injected wall material 1008, according to various embodiments. The reinforcement material 1002 includes fibers 1004 embedded with bonding material 1006. The bonding material 1006 is depicted on both sides of the fibers 1004 for convenience but typical reinforcement material 1002 includes a bonding material 1006 impregnated into the fibers 1004. At the interface between the bonding material 1006 and the injected wall material 1008, the injected wall material 1008 is bonded to the bonding material 1006 as the heated injected wall material 1008 melts the bonding material 1006. In other embodiments, the reinforcement material 1002 does not include the bonding material 1006 and the heated injected wall material 1008 bonds to the fibers 1004 of the reinforcement material 1002.

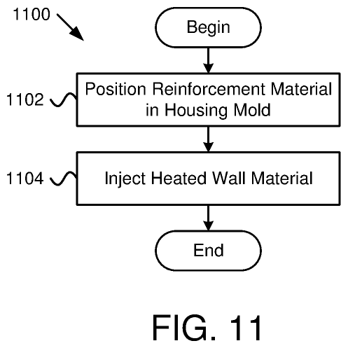

FIG. 11 is a schematic flowchart diagram illustrating a method 1100 for creating a circuit breaker housing 100 using an injected wall material with a reinforcement material along an outer surface, according to various embodiments. The method 1100 begins and positions 1102 a reinforcement material (e.g., 202, 302, 402, 502, 504, 702, 802, 1002) in a housing mold (e.g., 710, 804, 805 810, 904, 906) for a circuit breaker housing 100. The circuit breaker housing 100 includes outer walls on at least four sides and the reinforcement material is positioned to be on an outer surface of one or more of the at least four sides.

The method 1100 injects 1104 a heated wall material (e.g., 714, 814, 1008), using an injection molding process, in a portion of the housing mold interior to the reinforcement material to form the circuit breaker housing 100, and the method 1100 ends. The heated wall material bonds to the reinforcement material as the heated wall material is injected in the housing mold and the reinforcement material is in the outer surface of the one or more of the at least four sides of the circuit breaker housing 100.

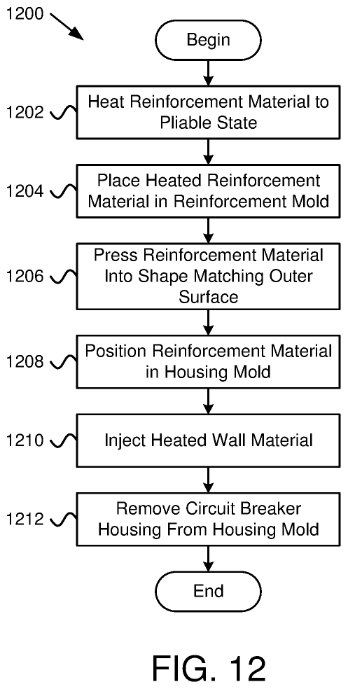

FIG. 12 is a schematic flowchart diagram illustrating a method 1200 for creating a circuit breaker housing 100 using an injected wall material with a reinforcement material along an outer surface where the reinforcement material is heated and pressed into shape, according to various embodiments. The method 1200 is similar to the process 700 of FIG. 7. The method 1200 is applicable to reinforcement material (e.g., 202, 302, 402, 502, 504, 702, 1002) impregnated with bonding material 1006. The method 1200 begins and heats 1202 reinforcement material to a pliable state and places 1204 the heated reinforcement material in a reinforcement mold (e.g., 708) and presses 1206 the heated reinforcement material into the reinforcement mold. The method 1200 positions 1208 the shaped reinforcement material into a housing mold (e.g., 710) and injects 1210 heated wall material (e.g., 714) into the housing mold and removes 1212 the formed circuit breaker housing 100 from the housing mold, and the method 1200 ends.

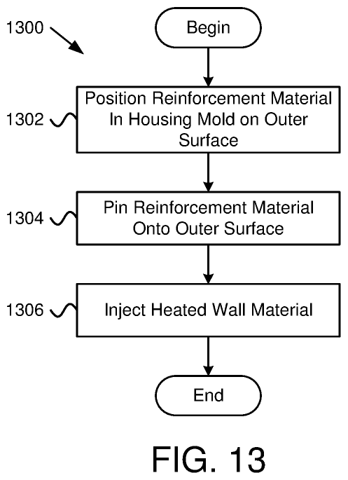

FIG. 13 is a schematic flowchart diagram illustrating a method 1300 for creating a circuit breaker housing 100 using an injected wall material with a reinforcement material along an outer surface where the reinforcement material is positioned in a mold and pinned in position, according to various embodiments. The method 1300 begins and positions 1302 reinforcement material (e.g., 202, 302, 402, 502, 504, 702, 902) in a housing mold 904, 906 such that the reinforcement material will be positioned on an outer surface of a circuit breaker housing 100. The method 1300 pins 1304 the reinforcement material in position and injects 1306 a heated wall material 814, using an injection molding process, in a portion of the housing mold interior to the reinforcement material to form the circuit breaker housing 100, and the method 1300 ends.

This description uses examples to disclose the invention and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A component comprising:
a circuit breaker housing comprising outer walls on at least four sides, the circuit breaker housing formed by injection of a heated wall material into a housing mold; and
a reinforcement material impregnated in an outer surface of one or more of the at least four sides,
wherein the reinforcement material is bonded to the circuit breaker housing during injection of the heated wall material.

2. The component of claim 1, wherein fibers of the reinforcement material are positioned in the one or more of the at least four sides in a direction to fortify the circuit breaker housing to resist pressures caused in a short circuit condition.

3. The component of claim 1, wherein the reinforcement material comprises unidirectional fibers.

4. The component of claim 1, wherein the reinforcement material comprises two or more layers, wherein each layer of the two or more layers comprises fibers running in a different direction than fibers of another layer of the two or more layers.

7. The component of claim 1, wherein a portion of the reinforcement material wraps around two or more adjacent sides of the circuit breaker housing.

6. The component of claim 5, wherein the portion of the reinforcement material wraps in a loop around four adjacent sides of the circuit breaker housing.

7. The component of claim 6, wherein the portion of the reinforcement material that wraps in a loop around the four adjacent sides of the circuit breaker housing comprises a strip less than a width of each of the four adjacent sides, the width measured in a direction perpendicular to the loop of reinforcement material and further comprising one or more strips of the reinforcement material running in a direction perpendicular to the loop of reinforcement material.

8. The component of claim 1, wherein the wall material comprises a thermoplastic resin.

9. The component of claim 1, wherein the reinforcement material is impregnated with a bonding material capable of bonding to the heated wall material when heated.

10. The component of claim 9, wherein the reinforcement material is the same as the wall material.

11. The component of claim 1, further comprising:
a circuit breaker within the circuit breaker housing; and/or and a faceplate attached to a side of the circuit breaker housing.

12. A method comprising:
positioning a reinforcement material in a housing mold for a circuit breaker housing, the circuit breaker housing comprising outer walls on at least four sides, the reinforcement material positioned to be on an outer surface of one or more of the at least four sides; and
injecting a heated wall material, using an injection molding process, in a portion of the housing mold interior to the reinforcement material to form the circuit breaker housing,
wherein the heated wall material bonds to the reinforcement material as the heated wall material is injected in the housing mold and the reinforcement material is in the outer surface of the one or more of the at least four sides of the circuit breaker housing.

13. The method of claim 12, wherein the reinforcement material is impregnated with bonding material capable of bonding to the heated wall material when heated.

14. The method of claim 13, further comprising, prior to positioning the reinforcement material in the housing mold:
heating the reinforcement material such that the bonding material is in a pliable state; and
pressing the reinforcement material into a shape matching a shape of an outer surface of the circuit breaker housing.

15. The method of claim 12, further comprising, after positioning the reinforcement material in the housing mold and prior to injecting the heated wall material, restraining the reinforcement material in a position where the reinforcement material was positioned in the housing mold.

16. The method of claim 12, wherein positioning the reinforcement material in the housing mold comprises positioning fibers of the reinforcement material in the housing mold in a location and direction to fortify the circuit breaker housing to resist pressures caused in a short circuit condition.

17. The method of claim 12, wherein the reinforcement material comprises two or more layers, wherein each layer of the two or more layers comprises fibers running in a different direction than fibers of another layer of the two or more

18. The method of claim 12, wherein the reinforcement material is impregnated with a bonding material capable of bonding to the heated wall material when heated.

19. A method comprising:
heating a reinforcement material impregnated with a bonding material, wherein the bonding material is heated to a pliable state;
placing the heated reinforcement material into a reinforcement mold;
pressing the reinforcement material in the reinforcement mold into a shape matching a shape of an outer surface of a circuit breaker housing, the circuit breaker housing comprising outer walls on at least four sides, the reinforcement material positioned to be on an outer surface of one or more of the at least four sides;
positioning the reinforcement material in a housing mold for the circuit breaker housing;
injecting a heated wall material, using an injection molding process, in a portion of the housing mold interior to the reinforcement material to form the circuit breaker housing; and
removing the circuit breaker housing from the housing mold,
wherein the bonding material of the reinforcement material is heated to a temperature such that the heated wall material bonds to the reinforcement material as the heated wall material is injected in the housing mold, and
wherein the reinforcement material is in one or more of the outer walls of the at least four sides of the circuit breaker housing.

20. The method of claim 19, wherein positioning the reinforcement material in the housing mold comprises positioning fibers of the reinforcement material in the housing mold in a location and direction to fortify the circuit breaker housing to resist pressures caused in a short circuit condition.
